(19) United States
(12) Patent Application Publication
(10) Pub. No.: US 2004/0186917 A1
(43) Pub. Date: Sep. 23, 2004

(54) Cross-region transferring device and system

(76) Inventor: Yean Ching Miao, Banchiau City (TW)

Correspondence Address: BIRCH STEWART KOLASCH & BIRCH, PO BOX 747, FALLS CHURCH, VA, 22040-0747, US

(21) Appl. No.: 10/393,021

(22) Filed: Mar. 21, 2003

(51) Int. Cl. G06F 15/16

(52) U.S. Cl. 709/249

(57) ABSTRACT

A cross-region transferring device, which cooperates with a regional network, a specific network, and a gateway device. The cross-region transferring device includes a first I/O module, an analysis module, and a second I/O module. The first I/O module receives an output packet from the gateway device via the regional network. The output packet records a cross-region destination. The analysis module analyses the output packet to retrieve the cross-region destination. The second I/O module outputs the output packet to the cross-region destination via the specific network. Furthermore, the invention also discloses a cross-region transferring system, including the cross-region transferring device, the gateway device, and the regional network.

### BACKGROUND OF THE INVENTION

1. Field of Invention

The invention relates to a cross-region transferring device and, in particular, to a cross-region transferring device for transferring data between different regional networks.

2. Related Art

As the acceptance of the Internet has grown widespread, related industries have risen and flourished. In general, a user must register an IP address to an ISP (Internet Service Provider) in advance, and then configure a gateway or terminal device, such as a PC or a VoIP device, with the provided IP address. Having completed these requirements, a user can then utilize the terminal and gateway device to connect to a regional network provided by the ISP. A user can then browse the Internet via that regional network.

However, many ISPs do not own their network cables or any of the infrastructure required for constructing regional networks. It is common for many ISPs to lease one or more network cables from other providers, and some ISPs even share bandwidth with other ISPs. Additionally, the ISPs must cooperate with each other, so as to ensure that users are able to connect to a desired IP address located in another regional network provided by another ISP.

With reference to FIG. 1, there are four regional networks 11-14 presented in Internet 10. A first terminal device 21 connects to the first regional network 11 through a gateway device 31. Similarly, second and third terminal devices 22, 23 respectively connect to the second and third regional network 12, 13 through gateway devices 32, 33. In this case, the first regional network 11 connects to the third and fourth regional networks 13, 14. The second regional network 12 connects to the third and fourth regional networks 13, 14. The third regional network 13 connects to the first, second and fourth regional networks 11, 12, 14. The fourth regional network 14 connects to the first, second and third regional networks 11, 12, 13. It should be noted that the data transmission speed between the regional networks is dependent upon the contract signed by the ISPs.

In practice, if the first terminal device 21 transfers data to the third terminal device 23, the data would then be output from the first terminal device 21 to the gateway device 31. The gateway device 31 would then output the packet formation data to the first regional network 11. Next, the packets are transferred from the first regional network 11 to the third regional network 13, and then are transferred from the third regional network 13 to the gateway device 33. Finally, the data can be successfully transferred from the gateway device 33 to the third terminal device 23. In this case, the data output from the first terminal device 21 is a voice analog signal or digital signal. If the data output from the first terminal device 21 is a voice analog signal, the gateway device 31 will translate the received voice analog signal into a digital signal and fragment the digital signal into several packets. The packets are then transferred to the gateway device 33, and the gateway device 33 can then reassemble and translate the packets into the original voice analog signal. After that, the voice analog signal is transferred to the third terminal device 23.

An alternative method does not require the packets to be transferred directly from the first regional network 11 to the third regional network 13. The packets could instead be transferred to the fourth regional network 14 first, and then be transferred from the fourth regional network 14 to the third regional network 13. Similarly, if the data is transferred from the first terminal device 21 to the second terminal device 22, the data will be fragmented into several packets, and be transferred via the gateway device 31, the first regional network 11, the fourth regional network 14, the second regional network 12, and the gateway device 32 in turn. The data may also be transferred via the gateway device 31, the first regional network 11, the third regional network 13, the second regional network 12, and gateway device 32 in turn.

Since data transmission capacity and speed are limited by contracts between ISPs, the packets are not necessarily being transferred to the destination via the proper (fastest) path. For instance, it is assumed that the first regional network 11 and the fourth regional network 14 are in Taiwan, the third regional network 13 is in California, and the ISPs providing the first, third and fourth regional network 11, 13, 14 have contractual agreements with each other. Under these contracts, the data transmission speed is 100 MB/sec between the first and fourth regional networks, 2 MB/sec between the first and third regional networks, and 10 MB/sec between the third and fourth regional networks. If the packets are transferred via the gateway device 31, first regional network 11 and third regional network 13 in turn, the maximum data transmission speed of the packets degrades to 2 MB/sec. If the packets are transferred via the gateway device 31, first regional network 11, fourth regional network 14 and third regional network 13 in turn, the maximum potential data transmission speed of the packets is 10 MB/sec. Accordingly, when the packets further pass through the fourth regional network 14, the data transmission speed between gateway device 31 and gateway device 33 could increase. That is, the preferred transfer path from gateway device 31 to gateway device 33 is via the first regional network 11, fourth regional network 14 and third regional network 13 sequentially.

In reality, the market mechanism is fluid and changes rapidly. For example, the ISPs providing the first and third regional networks 11, 13 could re-sign the contract to increase the data transmission speed between the first and third regional networks 11, 13 up to 30 MB/sec. Thus, when the packets are transferred from the first regional network 11 to the third regional network 13 directly, the data transmission speed between gateway device 31 and gateway device 33 is enhanced.

As mentioned above, when packets are transferred over a conventional regular network, the transfer path is not necessarily the preferred path. For instance, after the ISPs providing the first and third regional networks 11, 13 have re-signed the contract to increase the data transmission speed, the packets might not be transferred via the desired, better path at present but via the path established by the previous contracts. Thus, the packets are still transferred via the first regional network 11, the fourth regional network 14 and third regional network 13 in turn.

As mentioned above, it is an important objective of the invention to provide a cross-region transferring device and system for transferring packets between different regional networks via assigned or desired data transmission paths.

### SUMMARY OF THE INVENTION

In view of the previously mentioned problems, an objective of the invention is to provide a cross-region transferring device and system for transferring packets between different regional networks via an assigned specific network.

To achieve the above-mentioned objective, the invention provides a cross-region transferring device including a first I/O module, an analysis module, and a second I/O module. In the invention, the IP address of the cross-region transferring device is located in a regional network, and the cross-region transferring device is connected with a specific network and cooperates with a gateway device. The first I/O module receives an output packet from the gateway device via the regional network. The analysis module analyses the output packet to retrieve a cross-region destination recorded in the output packet. The second I/O module outputs the output packet to the cross-region destination via the specific network.

In addition, the invention also provides a cross-region transferring system. The cross-region transferring system includes a regional network, a gateway device, and a cross-region transferring device. In the invention, the gateway device and the cross-region transferring device are respectively connected to the regional network. The cross-region transferring device, as mentioned above, is further connected to a specific network. The cross-region transferring device receives an output packet, which records a cross-region destination, from the gateway device via the regional network. Then, the cross-region transferring device transfers the output packet to the cross-region destination via the specific network.

As previously mentioned, since the output packet of the invention records the cross-region destination, the cross-region transferring device and system could transfer the output packet to the cross-region destination located in another regional network via the assigned specific network.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram showing the conventional Internet structure;

FIG. 2 is a schematic diagram showing a cross-region transferring device according to a preferred embodiment of the invention;

FIG. 3 is a schematic diagram showing a cross-region transferring system according to a preferred embodiment of the invention;

FIG. 4 is a schematic diagram showing the structure of several cross-region transferring systems according to a preferred embodiment of the invention;

FIG. 5 is a flow chart showing the application of the cross-region transferring systems according to a preferred embodiment of the invention;

FIG. 6A is a schematic diagram showing an output packet transferred from a first gateway device to a first cross-region transferring device; and

FIG. 6B is a schematic diagram showing a packet transferred from a second cross-region transferring device to a second gateway device.

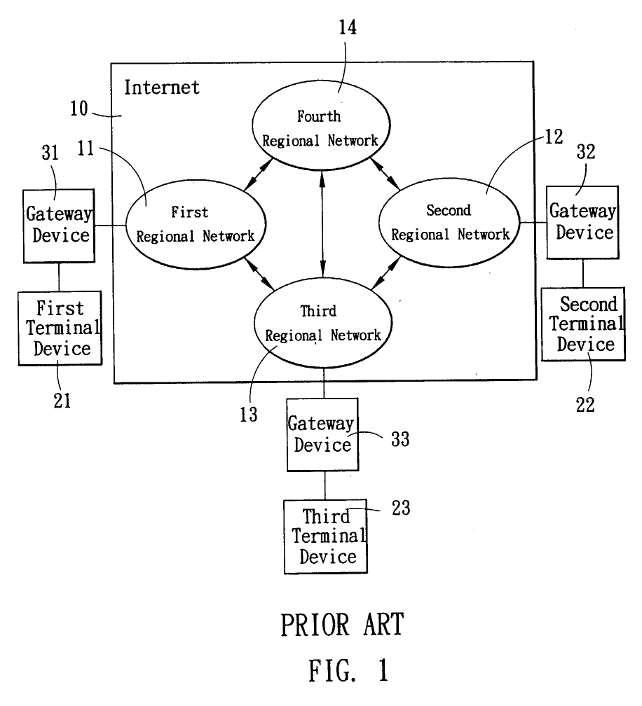

### DETAILED DESCRIPTION OF THE INVENTION

The cross-region transferring device and system according to the preferred embodiment of the invention will be described hereinbelow with reference to the accompany drawings, wherein the same reference numbers refer to the same elements.

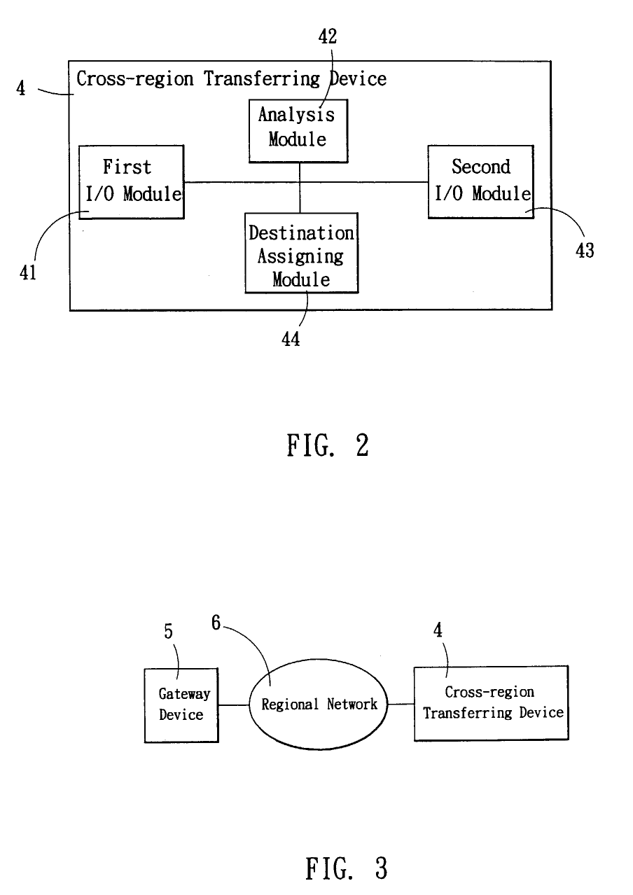

With reference to FIG. 2, a cross-region transferring device 4 according to a preferred embodiment of the invention includes a first I/O module 41, an analysis module 42, and a second I/O module 43.

The first I/O module 41 receives an output packet from a gateway device via the regional network. The output packet records a cross-region destination. In general, the output packet includes a header and a main data. The header of output packet includes the source and destination of the output packet. In the embodiment, when the output packet is output from the gateway device, the source of the output packet is the IP address of the gateway device, and the destination of that is the cross-region transferring device 4. Accordingly, following the regular network transmission protocol, the first I/O module 41 could receive the output packet. In addition, the main data of output packet records not only the data to be transferred, but also a cross-region destination. The cross-region destination is the address to which we want to transfer the output packet.

The analysis module 42 analyses the output packet that is received by the first I/O module 41 so as to retrieve the cross-region destination records in the main data of the output packet.

Moreover, the cross-region transferring device 4 further includes a destination assigning module 44 for assigning an another cross-region transferring device (not shown) to the destination of the output packet. In the current embodiment, the another cross-region transferring device is located in an another regional network, to which the cross-region destination belongs. After that, the second I/O module 43 outputs the output packet to the another cross-region transferring device via the specific network. Then, the another cross-region transferring device transfers the output packet to the cross-region destination via the another regional network. People skilled in the art should know that the cross-region destination could be the address of a gateway device or terminal device, so that the gateway device or terminal device could receive the output packet.

It should be noted that the output packet can further records a region distinguishing information, which is used for identifying the another regional network where the cross-region destination located. In this case, the analysis module 42 could further retrieve the region distinguishing information, so the second I/O module 43 could transfer the output packet to the another cross-region transferring device via the specific network according to the region distinguishing information.

Furthermore, the second I/O module 43 can receive an input packet via the specific network. The input packet records another cross-region destination, which is located in the mentioned regional network. The analysis module 42 can then analyze the input packet to retrieve the another cross-region destination. Accordingly, the first I/O module 41 could output the input packet to the regional network, and transfer it to the another cross-region destination via the regional network. In the embodiment, the another cross-region destination is just the address of the mentioned gateway device.

Please refer to FIG. 3. A cross-region transferring system is consist of the cross-region transferring device 4, a gateway device 5, and a regional network 6. In this case, the gateway device 5 and cross-region transferring device 4 are respectively connected to the regional network 6. The cross-region transferring device 4 further connects to a specific network. In the embodiment, the cross-region transferring device 4 receives an output packet, which records a cross-region destination, from the gateway device 5 via the regional network 6. Then, the cross-region transferring device 4 transfers the output packet to the cross-region destination via the specific network.

A cross-region transferring system of the present invention is described in greater detail with reference to the following embodiment.

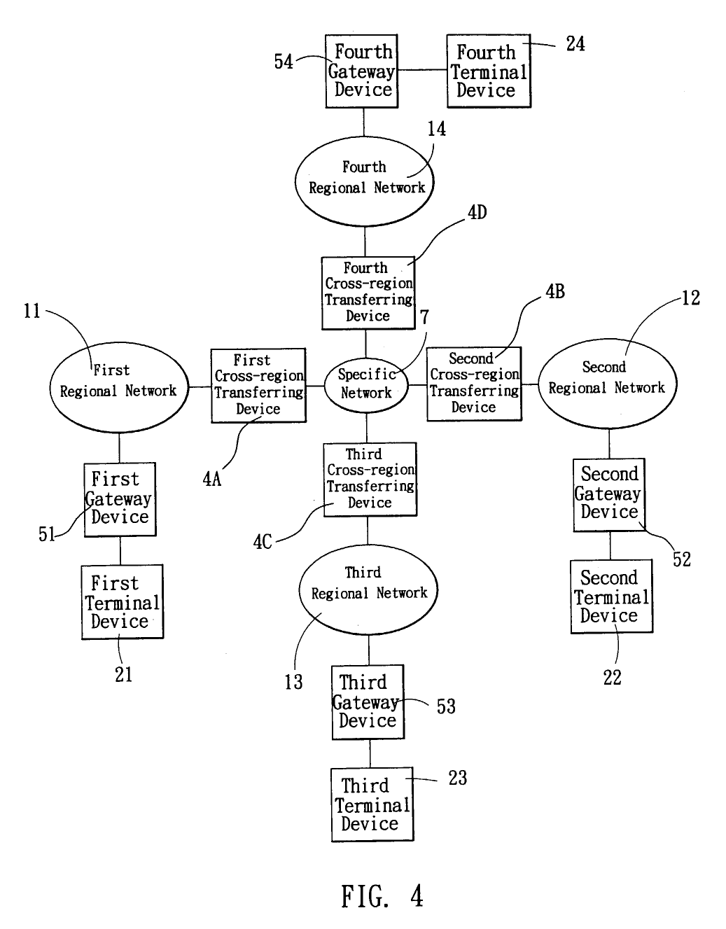

As shown in FIG. 4, a first cross-region transferring device 4A, a second cross-region transferring device 4B, a third cross-region transferring device 4C and a fourth cross-region transferring device 4D are connected with a first regional network 11, a second regional network 12, a third regional network 13 and a fourth regional network 14, respectively. The cross-region transferring devices 4A-4D further connect to the specific network 7. In addition, a first gateway device 51, a second gateway device 52, a third gateway device 53 and a fourth gateway device 54 are respectively connected with a first terminal device 21, a second terminal device 22, a third terminal device 23 and a fourth terminal device 24. The gateway devices 51-54 further connect to the regional networks 11-14, respectively.

It should be noted that the data transmission speed between each regional network depends on the contracts of each ISP. This means that the bandwidth between the regional networks is limited by contracts between the ISPs. In the invention, the specific network 7 can be designated as a private network. Therefore, the bandwidth of the specific network 7 can be fully controlled, and the specific network 7 offers truly superior data transmission quality.

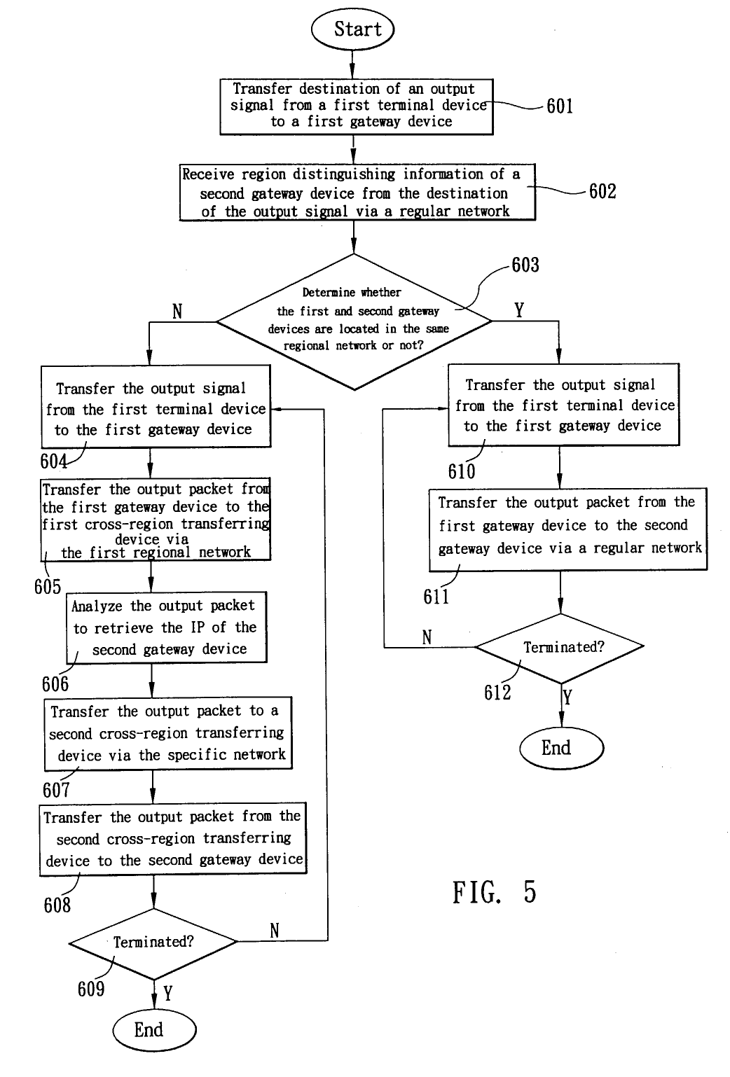

Please refer to FIG. 5. In step 601, when communicating with the second terminal device 22 via the Internet, the first terminal device 21 transfers the destination of an output signal to the first gateway device 51 in advance. Alternatively, the first terminal device 21 can transfer the output signal to the first gateway device 51, and then the first gateway device 51 analyses the output signal to retrieve the required destination. In the current embodiment, the output signal is a digital signal while the first terminal device 21 is a computer; or, the output signal may be a voice signal and the destination is expressed by dial tones while the first terminal device 21 is a telephone.

After receiving the destination of the output signal, the first gateway device 51 receives region distinguishing information from the second gateway device 52 via a regular network in step 602. In the embodiment, the first gateway device 51 receives the output signal or the destination thereof, and then generates a region distinguishing information-inquiring signal according to the received destination. Next, the region distinguishing information-inquiring signal is output from the first gateway device 51 to the first regional network 11. Thus, the region distinguishing information-inquiring signal is transferred to the second gateway device 52 via a regular network. For example, the region distinguishing information-inquiring signal might pass through the first regional network 11, third regional network 13, second regional network 12 and second gateway device 52 in turn. After receiving the region distinguishing information-inquiring signal, the second gateway device 52 responds with the region distinguishing information, which is transferred to the first gateway device 51 via a regular network. The region distinguishing information indicates the second regional network 12 in which the second gateway device 52 is located.

In step 603, the received region distinguishing information is analyzed so as to determine whether the first and second gateway devices 51, 52 are located in the same regional network or not. In the embodiment, if the first and second gateway devices 51, 52 aren't located in the same regional network, the first and second gateway devices 51, 52 establish a communication channel thereof via the first cross-region transferring device 4A and second cross-region transferring device 4B (step 604-609). Alternatively, if the first and second gateway devices 51, 52 are located in the same regional network, the first and second gateway devices 51, 52 establish a communication channel thereof via a regular network (step 610-612). The first and second cross-region transferring devices 4A, 4B are both the above-mentioned cross-region transferring device 4.

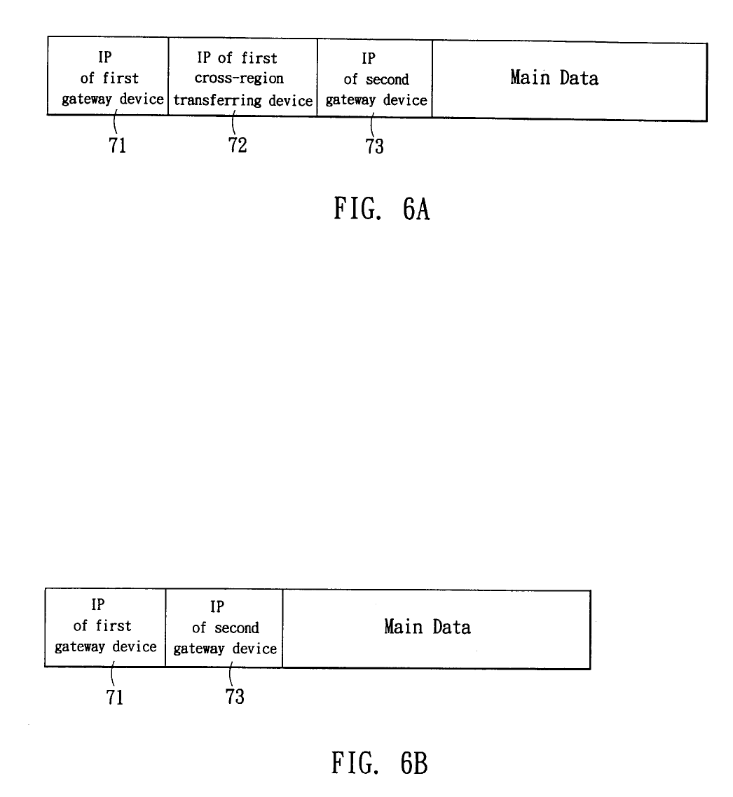

The first gateway device 51 receives the output signal from the first terminal device 21 in step 604. Furthermore, the first gateway device 51 translates and fragments the output signal into at least an output packet in cases where the output signal isn't a packet formation. Then, the first gateway device 51 outputs the output packet to the first cross-region transferring device 4A via the first regional network 11, and the first I/O module of the first cross-region transferring device 4A receives the output packet (step 605). The destination of the above-mentioned output packet, which is shown in FIG. 6A, is the first cross-region transferring device 4A. The header of the output packet should include the IP of the first gateway device 71 and the IP of the first cross-region transferring device 72. The destination of the output signal, as well as the IP of the second gateway device 73, is also recorded in the output packet. In this case, the destination of the output signal is the mentioned cross-region destination.

In step 606, the analysis module of the first cross-region transferring device 4A analyses the output packet and retrieves the IP of the second gateway device 73 recorded in the main data of the output packet. Then, the second I/O module of the first cross-region transferring device 4A transfers the output packet to the second cross-region transferring device 4B via the specific network 7 (step 607). In step 608, the second cross-region transferring device 4B transfers the output packet to the second gateway device 52, and then the second gateway device 52 transfers the output packet to the second terminal device 22. The output packet transferred to the second gateway device 52 are shown in FIG. 6B, wherein the header of the output packet should include the IP of the first gateway device 71 and the IP of the second gateway device 73. Finally, step 609 determines whether the communication is terminated or not. If not, steps 604-609 are repeated; if so, the procedure is terminated.

Furthermore, when the first and second gateway devices 51, 52 are located in different regional networks, the first gateway device 51 is further able to receive at least one input packet transferred from the second gateway device 52 via the second cross-region transferring device 4B, specific network 7 and first cross-region transferring device 4A in turn. In this case, the input packet has a data structure similar to a conventional regular packet during being transferred from the first cross-region transferring device 4A to the first gateway device 51. The destination of the input packet is the IP of the first gateway device 51, while the source of the input packet is the IP of the second gateway device 52. The first gateway device 51 further translates the input packet into an input signal and outputs the input signal to the first terminal device 21. In the embodiment, the input signal could be a digital signal, an analog signal, or a voice signal.

When the first and second gateway devices are located in the same regional network (not shown in FIG. 4), the first gateway device receives the output signal from the first terminal device (step 610). If the output signal isn't a packet formation, the first gateway device will translate the output signal into at least an output packet. Next, in step 611, the first gateway device transfers the output packet to the second gateway device via a regular network, which is the first regional network. The output packet is shown in FIG. 6B. Finally, the step 612 determines whether the communication is terminated or not. If not, steps 610-612 are repeated; if so, the procedure is terminated.

It should be noted that the first gateway device 51 is able to establish a communication channel with any other gateway device via the cross-region transferring devices, for instance, the second gateway device 52 or the third gateway device 53 shown in FIG. 4.

In summary, since the output packet of the invention records the cross-region destination, the cross-region transferring device or system of the invention can analyze the output packet to retrieve the cross-region destination. Therefore, the output packet can be transferred to the cross-region destination located in another regional network via the superior specific network.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A cross-region transferring device, which is located in a regional network, signally connects to a specific network, and cooperates with a gateway device, comprising:
a first I/O module, which receives an output packet from the gateway device via the regional network, the output packet recording a cross-region destination;
an analysis module, which analyses the output packet to retrieve the cross-region destination; and
a second I/O module, which transfers the output packet to the cross-region destination via the specific network.

2. The cross-region transferring device of claim 1, which further cooperates with an another cross-region transferring device, the another cross-region transferring device and the cross-region destination are located in an another regional network, wherein:
the second I/O module transfers the output packet to the another cross-region transferring device via the specific network, and then the another cross-region transferring device transfers the output packet to the cross-region destination via the another regional network.

3. The cross-region transferring device of claim 2, further comprising:
a destination assigning module, which assigns the another cross-region transferring device as the destination of the output packet.

4. The cross-region transferring device of claim 1, wherein the second I/O module further receives at least an input packet from the specific network, and the input packet records an another cross-region destination.

5. The cross-region transferring device of claim 4, wherein the first I/O module further transfers the input packet to the another cross-region destination via the regional network.

6. The cross-region transferring device of claim 5, wherein the destination of the input packet output from the first I/O module is the another cross-region destination.

7. A cross-region transferring system, which cooperates with a specific network, comprising:
a regional network;
a gateway device, which signally connects to the regional network; and
a cross-region transferring device, which connects to the specific network and the regional network,
wherein, the cross-region transferring device receives an output packet recording a cross-region destination from the gateway device via the regional network, and transfers the output packet to the cross-region destination via the specific network.

8. The cross-region transferring system of claim 7, wherein the cross-region transferring device comprises:
a first I/O module, which receives the output packet from the gateway device via the regional network;
an analysis module, which analyses the output packet to retrieve the cross-region destination; and
a second I/O module, which transfers the output packet to the cross-region destination via the specific network.

9. The cross-region transferring system of claim 8, which further cooperates with an another cross-region transferring device, the another cross-region transferring device and the cross-region destination are located in an another regional network, wherein:
the second I/O module transfers the output packet to the another cross-region transferring device via the specific network, and then the another cross-region transferring device transfers the output packet to the cross-region destination via the another regional network.

10. The cross-region transferring system of claim 9, wherein the cross-region transferring device further comprising:
a destination assigning module, which assigns the another cross-region transferring device as the destination of the output packet.

11. The cross-region transferring system of claim 8, wherein the second I/O module further receives at least an input packet from the specific network, and the input packet records an another cross-region destination.

12. The cross-region transferring system of claim 11, wherein the first I/O module further transfers the input packet to the another cross-region destination via the regional network.

13. The cross-region transferring system of claim 12, wherein the destination of the input packet output from the first I/O module is the another cross-region destination.
